(19) United States
(12) Patent Application Publication
(10) Pub. No.: US 2005/0141163 A1
(43) Pub. Date: Jun. 30, 2005

(54) Analogue electronic trip device for an electrical power breaker responding to a short-circuit

(76) Inventors: Henry Franke, Berlin (DE); Uwe Gnoerrlich, Berlin (DE); Marc Liebetruth, Berlin (DE); Andreas Pancke, Berlin (DE); Wolfgang Rohl, Berlin (DE)

Correspondence Address: HARNESS, DICKEY & PIERCE, P.L.C., P.O.BOX 8910, RESTON, VA, 20195, US

(21) Appl. No.: 10/508,790

(22) PCT Filed: Mar. 13, 2003
(86) PCT No.: PCT/DE03/00896

(30) Foreign Application Priority Data
Mar. 26, 2002 (DE) 102142343

(51) Int. Cl. H02H 3/00

(52) U.S. Cl. 361/94; 361/96

(57) ABSTRACT

A trip device is for an electrical power breaker, for tripping on a short-circuit. It is embodied as an analogue electrical circuit. The circuit components and devices necessary for tripping on a short circuit form a discrete module, completely independent of other trip devices on the power breaker. A direct current is provided by transformers together with rectifiers which flows through a power semiconductor switched to conduct in the normal operating state of the power breaker. A measurement and control circuit is controlled by way of a voltage generated across a measuring resistance through which the direct current flows and closes the power semiconductor when a threshold value is exceeded. The current is then commutated from the power semiconductor to the trip magnet which opens the switch contacts with a particularly small delay.

This application is the national phase under 35 U.S.C. § 371 of PCT International Application No. PCT/DE03/00896 which has an International filing date of Mar. 13, 2003, which designated the United States of America and which claims priority on German Patent Application number DE 102 14 234.3 filed Mar. 26, 2002, the entire contents of which are hereby incorporated herein by reference.

### FIELD OF THE INVENTION

The invention generally relates to an analog-electronic tripping device for an electrical power breaker responding to a short circuit. Preferably, it relates to one having
a current transformer for detecting a current flowing in a circuit monitored by the power breaker,
a tripping magnet for releasing switching contacts of the power breaker,
a threshold circuit for outputting a switching command for the tripping magnet when the detected current exceeds a limit value,
a power supply circuit for operating the tripping device and the tripping magnet.

### BACKGROUND OF THE INVENTION

A tripping device has been disclosed in U.S. Pat. No. 4,733,321 (=EP 0 244 284 B1). This tripping device forms, together with a further tripping device provided for the purpose of monitoring an overload, a complete protective device for the power breaker for the most common faults during operation of electrical systems. In this case, separate current transformers and different switching devices are used for measuring the current in the overload range and for the short-circuit range. In the tripping device for the overload range, an inductive current transformer is used in conjunction with a microprocessor device, whilst a sensor based on a Rogowski coil in conjunction with an analog-electronic circuit serves the purpose of detecting short circuits. The Rogowski coil emits a signal (di/dt) corresponding to the change over time in the current.

An integrated circuit can then be used to obtain from this a signal which is directly proportional to the current. The two signals, current change and current, are evaluated in order to cause the power breaker to trip as required. Since the Rogowski coil does not provide any power for operating the evaluation circuit and the tripping magnet, a separate power supply circuit is provided for this purpose.

The reason for selecting an analog-electronic circuit for tripping purposes in the event of a short circuit is that it requires considerably less time to process an input signal than a microprocessor device. Microprocessor devices require a considerable ramp-up time, in particular when they are started up from the de-energized state. Even in the standby state, a microprocessor device requires, owing to its sequential mode of operation, a period of time for processing signals which is considered to be disruptively long for the purpose of disconnecting a short circuit. For this application, on the other hand, the high accuracy and the wide operating range of a microprocessor device is not required, since only a single limit value is relevant here.

It is also known in this context, likewise by applying the principle of isolated circuit sections for overloads and short circuits, to use a common inductive current transformer (U.S. Pat. No. 4,689,712=EP 0 193 448 B1). However, the resultant greater extent to which the two tripping branches are combined makes it more difficult to achieve the very short time delay required for tripping in the event of a short circuit.

### SUMMARY OF THE INVENTION

An embodiment of the invention is based on a comparison of different known tripping devices in which it has been established that, despite sensible precautions, tripping in the event of a short circuit takes place with an undesired time delay. Such a time delay is all the more disruptive the higher the switching capacity of a power breaker. On this basis, an embodiment of the invention may include an object of creating a tripping device having a reduced and even minimum response time.

According to an embodiment of the invention, an object may be achieved in that
the current transformer is in the form of a power-supplying current transformer,
connected downstream of the current transformer is a rectifier circuit for the purpose of converting the detected current into a direct current,
the current transformer and the rectifier circuit form the power supply circuit, and
connected in parallel with the tripping magnet is a controllable power semiconductor which can be controlled by the measuring and control circuit such that it is turned fully on when the limit value is undershot and is turned fully off when the limit value is exceeded.

An embodiment of the invention provides a tripping device which responds to a short circuit, which operates fully autonomously and, as a result, is in every respect independent of the tripping device for a long time delay and a short time delay. The extremely rapid response of the new tripping device, however, is not based on this independent design alone, but on the fact that the power for actuating the tripping magnet is made available as a precaution. For example, owing to the fact that a power-supplying current transformer (as opposed to a signal transmitter) is used, and this provides a constant supply for an auxiliary circuit, it is only necessary to switch (commutate) the current supplied by the current transformer from the auxiliary circuit to the tripping magnet. An extremely short amount of time is required for this switching (commutation), which takes place by the power semiconductor which is connected in parallel with the tripping magnet being turned off.

It is essential for problem-free continuous operation of the tripping device that the power semiconductor is maintained in a low-loss state. According to one refinement of the invention, this may be assisted by the power semiconductor being connected to a feedback branch for the purpose of maintaining its fully on state.

In addition, a capacitor which can be charged by turning the power semiconductor off for a short period of time may be provided for the purpose of providing a control current required for maintaining an on state of the power semiconductor. Since the time required for charging is short, the tripping magnet remains at rest during these charging processes which are repeated periodically.

With the abovementioned, known tripping devices, the tripping magnet is used not only for tripping purposes in the event of a short circuit but also for other forms of tripping, in particular in the event of an overcurrent or a ground fault. For this purpose, the different tripping signals may be combined in an OR circuit, whose output acts on the single tripping magnet. A time delay which may be caused by this can be prevented according to a further development of the invention by the tripping magnet being a separate tripping magnet which is only connected to the tripping device responding to a short circuit.

In addition to dispensing with the OR gate, this also makes it possible to select a tripping magnet which is particularly suitable for the specific purpose and to thereby further reduce the tripping delay. In particular owing to the use of a dedicated tripping magnet for the short-circuit tripping, the tripping device according to an embodiment of the invention becomes an independent component which is completely separate from the other tripping devices. This has the advantage that this component can be manufactured, tested and replaced independently.

### BRIEF DESCRIPTION OF THE DRAWINGS

Further advantages, features and details of the invention will become evident from the description of illustrated exemplary embodiments given hereinbelow and the accompanying drawings, which are given by way of illustration only and thus are not limitative of the present invention, wherein:

FIG. 1 illustrates, in a graph, the dependence of the trip time on the current in a low-voltage power breaker.

FIG. 2 shows the block circuit of a tripping device according to an embodiment of the invention.

FIG. 3 shows a detailed circuit diagram of a circuit branch shown in simplified, block form in FIG. 2.

FIG. 4 shows periodic charging of a capacitor used for operating a power semiconductor.

### DETAILED DESCRIPTION OF THE EXEMPLARY EMBODIMENTS

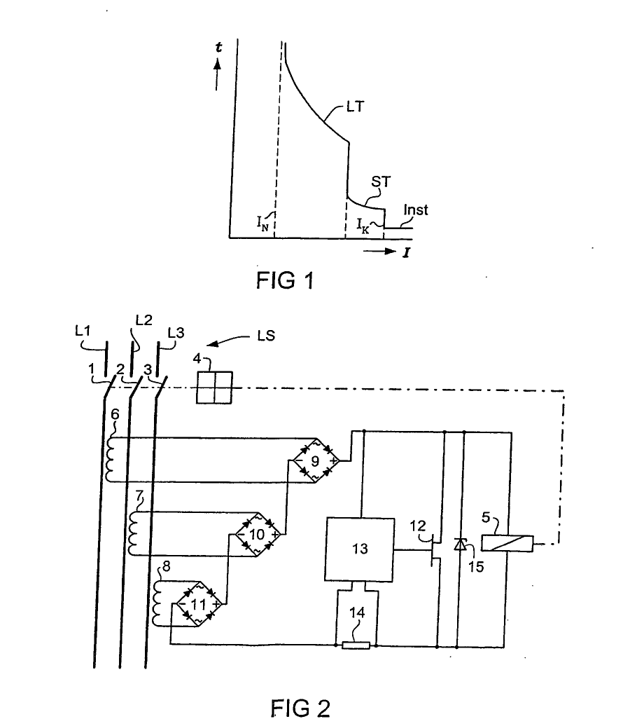

In the graph shown in FIG. 1, the time and the current are plotted on a logarithmic scale in a known manner. At currents above the rated current I_{N}, there begins the overload region LT in which relatively long tripping time delays occur (minutes to hours). In the subsequent short time delay region ST, the tripping times are in fractions of seconds to seconds.

For the two sections LT and ST of the tripping characteristic, the time delays are determined by an electronic tripping device on the basis of a microprocessor device. Currents above a limit value I_{K} are considered as short circuits and require the power breaker to be tripped with the shortest possible time delay in order to prevent the protected system and the power breaker itself from being damaged. As was mentioned initially, analog-electronic circuits are used for this undelayed tripping.

The solution according to an embodiment of the invention of such an analog-electronic tripping device for a short circuit is shown in FIG. 2 as a simplified block circuit diagram. In the path of conductors L1, L2 and L3 of a power supply system are switching contacts 1, 2 and 3 of a power breaker LS. An actuating device 4 makes it possible in a known manner to arbitrarily close and open the switching contacts 1, 2 and 3 and, in particular, for them to be automatically opened by means of a tripping magnet 5.

The currents flowing in the conductors L1, L2 and L3 are detected by in each case one current transformer 6, 7 and 8. These current transformers are preferably designed such that it is possible both to obtain a signal dependent on the current and to supply a specific power. These conditions are generally met by current transformers which have an iron core and a secondary winding fitted thereon, the primary winding of this current transformer being formed by the conductors L1, L2 and L3.

The alternating currents output by the current transformers 6, 7 and 8 are converted into a direct current by way of in each case one rectifier bridge circuit 9, 10 and 11. The three rectifier bridge circuits 9, 10 and 11 are connected in series such that there is available at the ends of this series circuit a total current which represents the action of the currents in the conductors L1, L2 and L3. Specifically dimensioning said current transformers 6, 7 and 8 and the rectifier bridge circuits 9, 10 and 11 ensures that sufficient power is made available for actuating the tripping magnet 5 when a short-circuit current flows in the conductors L1, L2 and L3.

During normal operation, i.e. when normal operating currents flow in the conductors L1, L2 and L3, the current supplied by the rectifier bridge circuits 9, 10 and 11 does not flow through the tripping magnet 5, but through an auxiliary circuit which is formed by a fully on power semiconductor 12. The current transformers 6, 7 and 8 in this case operate in the short circuit. This state is maintained by a measuring and control circuit 13, whose operating power is likewise derived from the direct current supplied by the rectifier bridge circuits 9, 10 and 11. The voltage occurring across a measuring resistor 14 is supplied as an input variable to the measuring and control circuit 13.

A specific voltage which occurs across the measuring resistor 14 and is processed in the measuring and control circuit 13 corresponds to a short-circuit current in the conductors L1, L2 and L3. This results in the auxiliary circuit being interrupted by the power semiconductor 12 being turned off. The current which has until now been flowing through the power semiconductor 12 is then commutated to the tripping magnet 12. A limiter diode 15 in this case acts as protection for the power semiconductor 12. The tripping magnet 5 is in this case activated particularly rapidly by over-excitation or high-speed excitation. The switching contacts 1, 2 and 3 are opened at the same speed (FIG. 2).

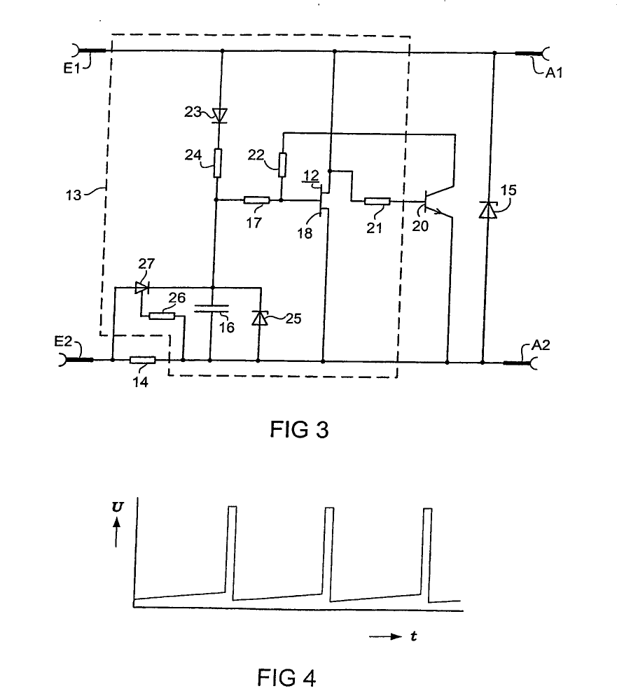

Details of the measuring and control circuit 13 are explained below with reference to FIGS. 3 and 4.

In the circuit shown in FIG. 3, the inputs E1 and E2 correspond to the ends of the series circuit including the rectifier bridge circuits 9, 10 and 11. The outputs A1 and A2 are the connection points for the tripping magnet 5 in FIG. 2. The power semiconductor 12 is brought into a fully on state by a control current, which is provided by way of a capacitor 16 and is applied to a control electrode 18 of the power semiconductor 12 by way of a resistor 17. Also connected to the control electrode 18 is a feedback branch, which is essentially formed by a transistor 20 and associated resistors 21 and 22.

As the charging of the capacitor 16 eases off and the control current across the control electrode 18 is correspondingly reduced, the voltage occurring across the power semiconductor 12 increases, which, owing to the transistor 20 being turned off, results in the feedback being interrupted and the power semiconductor 12 being turned off. By removing the short circuit across the supplying current transformers 6, 7 and 8, the voltage across E1 and E2 now jumps to a higher value which is suitable for charging or recharging the capacitor 16 by use of a diode 23 and a charging resistor 24. A limiter diode 25 in this case provides a defined final value for the charge voltage. The previous state is now reached again, i.e. the power semiconductor 12 is switched fully on.

While the capacitor 16 is being recharged, the increased voltage is also applied to the outputs A1 and A2, to which the tripping magnet 5 is connected. As is shown in FIG. 4, however, the times required for charging the capacitor 16 are so short that the tripping magnet 5 (FIG. 2) does not respond. The capacitor 16 is recharged periodically, as is also illustrated in FIG. 4.

As has been mentioned above, the measuring resistor 14 is provided for the purpose of detecting the direct current supplied by the rectifier bridge circuits 9, 10 and 11. If the voltage exceeds a limit value corresponding to a short-circuit current in the conductors L1, L2 and L3 (FIG. 2), a reference diode 27 is turned on by way of a resistor 26, which results in the capacitor 16 being discharged immediately. As a result, the power semiconductor 12 is turned off and the flowing current commutates from the power semiconductor 12 to the tripping magnet 5 connected to the outputs A1 and A2. This rapidly opens the switching contacts 1, 2 and 3 of the power breaker LS (FIG. 2).

Although the reference diode 26 shown in FIG. 3 is a component which is suitable for the particular purpose, and can easily be provided with the desired properties, other components or circuits comprising components may also be used with the same result. For example, a conventional comparator may be used.

From the above description it can be seen that the tripping device according to an embodiment of the invention is a fully autonomous component in terms of its function. It includes all and only those elements which together cause the power breaker LS (FIG. 2) to trip in the event of a short circuit. This makes it possible to produce and to test short-circuit releases independently of other protective devices for a power breaker, in particular independently of tripping devices for the characteristic sections LT and ST in FIG. 1. This is an important factor when fitting and later monitoring a power breaker during operation.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An analog-electronic tripping device for an electrical power breaker responding to a short circuit, comprising:
a current transformer, in the form of a power-supplying current transformer, adapted to detect a current flowing in a circuit monitored by the power breaker;
a tripping magnet, adapted to release switching contacts of the power breaker;
a measuring and control circuit, adapted to for activate the tripping magnet when the detected current exceeds a limit value;
a rectifier circuit, connected downstream of the current transformer, adapted to convert the detected current into a direct current, wherein
the current transformer and the rectifier circuit form a power supply circuit; and
a controllable power semiconductor, connected in parallel with the tripping magnet, adapted to be controlled by the measuring and control circuit, wherein the controllable power semiconductor is turned fully on when the limit value is undershot and is turned fully off when the limit value is exceeded.

2. The tripping device as claimed in claim 1, wherein
the power semiconductor is connected to a feedback branch for maintaining the fully on state.

3. The tripping device as claimed in claim 1, further comprising:
a capacitor, chargeable by turning the power semiconductor off for a short period of time, for providing a control current required for maintaining an on state of the power semiconductor.

4. The tripping device as claimed in claim 1, wherein
the tripping magnet is a separate tripping magnet which is only connected to the tripping device responding to a short circuit.

5. The tripping device as claimed in claim 2, further comprising:
a capacitor, chargeable by turning the power semiconductor off for a short period of time, for providing a control current required for maintaining an on state of the power semiconductor.

6. The tripping device as claimed in claim 2, wherein the tripping magnet is a separate tripping magnet which is only connected to the tripping device responding to a short circuit.

7. The tripping device as claimed in claim 3, wherein the tripping magnet is a separate tripping magnet which is only connected to the tripping device responding to a short circuit.

8. The tripping device as claimed in claim 5, wherein the tripping magnet is a separate tripping magnet which is only connected to the tripping device responding to a short circuit.

9. An analog-electronic tripping device for an electrical power breaker responding to a short circuit, comprising:
first means, including a power-supplying current transformer, for detecting a current flowing in a circuit monitored by the power breaker;
second means for releasing switching contacts of the power breaker;
third means for activating the second means when the detected current exceeds a limit value;
fourth means, connected downstream of the first means, for converting the detected current into a direct current, wherein the first and fourth means form a power supply circuit; and
fifth means, connected in parallel with the second means and controllable by the third means, for turning on fully when the limit value is undershot and for turning off fully when the limit value is exceeded.

10. The tripping device as claimed in claim 9, wherein the fifth means is connected to a feedback branch for maintaining the fully on state.

11. The tripping device as claimed in claim 9, further comprising:
sixth means, chargeable by turning the fifth means off for a short period of time, for providing a control current required for maintaining an on state of the fifth means.

12. The tripping device as claimed in claim 9, wherein the second means includes a separate tripping magnet which is only connected to the tripping device responding to a short circuit.

13. The tripping device as claimed in claim 10, further comprising:
sixth means, chargeable by turning the fifth means off for a short period of time, for providing a control current required for maintaining an on state of the fifth means.

14. The tripping device as claimed in claim 10, wherein the second means includes a separate tripping magnet which is only connected to the tripping device responding to a short circuit.

15. The tripping device as claimed in claim 11, wherein the second means includes a separate tripping magnet which is only connected to the tripping device responding to a short circuit.

16. The tripping device as claimed in claim 13, wherein the second means includes a separate tripping magnet which is only connected to the tripping device responding to a short circuit.

17. A method for an electrical power breaker responding to a short circuit, comprising:
detecting a current flowing in a circuit monitored by the power breaker;
activating tripping magnet, releasing switching contacts of the power breaker, when the detected current exceeds a limit value;
converting the detected current into a direct current using a measuring and control circuit; and
controlling a controllable power semiconductor using the measuring and control circuit, wherein the controllable power semiconductor is turned fully on when the limit value is undershot and is turned fully off when the limit value is exceeded.
